(19) United States
(12) Patent Application Publication
(10) Pub. No.: US 2020/0331100 A1
(43) Pub. Date: Oct. 22, 2020

(54) METHODS AND LASER PROCESSING MACHINES FOR THE SURFACE STRUCTURING OF LASER-TRANSPARENT WORKPIECES

(71) Applicant: TRUMPF Laser- und Systemtechnik GmbH, Ditzingen (DE)

(72) Inventor: Sören Richter, Ditzingen (DE)

(21) Appl. No.: 16/918,440

(22) Filed: Jul. 1, 2020

Related U.S. Application Data
(63) Continuation of application No. PCT/EP2018/085007, filed on Dec. 14, 2018.

(30) Foreign Application Priority Data
Jan. 3, 2018 (DE) 102018200029.8

(51) Int. Cl. B23K 26/352; B23K 26/0622; B23K 26/53; B23K 26/06; B23K 26/03; B23K 26/082; B23K 26/08; B23K 26/00; C03C 3/06; C03C 23/00

(52) U.S. Cl. CPC B23K 26/352; B23K 26/0624; B23K 26/53; B23K 26/0665; B23K 26/03; B23K 2103/42; B23K 26/082; B23K 26/083; B23K 26/0006; C03C 3/06; C03C 23/0025; B23K 26/0648

(57) ABSTRACT

The disclosure provides methods and systems for producing surface structures on a laser-transparent workpiece, e.g. a glass or plastic workpiece, wherein one or more USP laser pulses are focused into the laser-transparent workpiece through the workpiece surface (11), to melt a modification in the workpiece interior by heating a focus volume, wherein the pulse parameters of the at least one USP laser pulse and the depth of the laser focus in the workpiece are chosen in such a way that the topmost part of the melted modification nearly touches the workpiece surface and the workpiece surface bulges outward to form a convex surface structure by means of thermal material expansion of the melted modification.

### CROSS REFERENCE TO RELATED APPLICATIONS

This application is a continuation of and claims priority under 35 U.S.C. § 120 from PCT Application No. PCT/EP2018/085007, filed on Dec. 14, 2018, which claims priority from German Application No. 10 2018 200 029.8, filed on Jan. 3, 2018. The entire contents of each of these priority applications are incorporated herein by reference.

### TECHNICAL FIELD

The disclosure relates to a method for producing surface structures on laser-transparent workpieces, e.g., glass or plastic workpieces.

### BACKGROUND

Ultrashort pulsed (USP) laser radiation, e.g., laser radiation with pulse durations that are less than about 10 ps, is increasingly being used for material processing. One feature of material processing with USP laser radiation is the short interaction time of the laser radiation with the workpiece. The laser welding of laser-transparent glasses using ultrashort (USP) laser pulses can provide a stable connection without additional material use, but may be limited by laser-induced transient and permanent stresses. The laser welding may be accomplished by local melting of the material using ultrashort laser pulses. If ultrashort laser pulses are focused into a volume of glass, e.g., fused silica, the high intensity present at the focus can lead to nonlinear absorption processes, as a result of which, depending on the laser parameters, various material modifications can be induced. If the temporal pulse spacing is shorter than a typical thermal diffusion time of the glass, the temperature in the focus region increases from pulse to pulse (so-called heat accumulation) and can lead to local melting. If the modification is positioned in the interface of two glasses, the cooling melt can generate a stable connection of the two samples.

The article “Toward laser welding of glasses without optical contacting” by Soren Richter (Appl. Phys. A 2015) and the dissertation “Direct laser bonding of transparent materials using ultrashort laser pulses at high repetition rates” (FSU University Jena) by Soren Richter describe how laser bonding can be used to bridge a gap between two glass plates that overlap each other by means of laser-induced modifications which bulge out from the bonding surface of one bonding partner until cohesive connection to the bonding surface of the other bonding partner is attained.

### SUMMARY

The present disclosure provides methods and systems for producing, on laser-transparent workpieces, reproducible and stable surface structures, e.g., in the shape of spherical segments and their derivatives, with a height of a few μm and without additional substructures.

In one aspect, the disclosure provides methods for producing surface structures on a laser-transparent workpiece, e.g., a workpiece made of glass or plastic, using a pulsed laser beam in the form of USP laser pulses, wherein at least one USP laser pulse is focused into the laser-transparent workpiece through the workpiece surface, to melt a modification in the workpiece interior by heating the focus volume, and wherein the pulse parameters of the at least one USP laser pulse and the depth of the laser focus in the workpiece are chosen in such a way that the topmost part of the melted modification nearly touches the workpiece surface and the workpiece surface bulges outward to form a convex surface structure by means of thermal material expansion of the melted modification. In the case of a single USP laser pulse, the modification can be produced without heat accumulation, where pulse energy can be selected so that it is not so low that only a refractive index modification occurs and not so high that the induced stresses cause mechanical breakage.

In one embodiment, a plurality of USP laser pulses are focused into the laser-transparent workpiece through the workpiece surface, to melt a modification in the workpiece interior by heating the focus volume step-by-step, wherein the pulse parameters of the plurality of USP laser pulses and the depth of the laser focus in the workpiece are chosen in such a way that the topmost part of the melted modification nearly touches the workpiece surface and the workpiece surface bulges outward to form a convex surface structure by means of thermal material expansion of the melted modification. In some embodiments, a plurality of ultrashort laser pulses with low temporal pulse spacing are focused into the workpiece interior material; due to nonlinear interaction and the heat accumulation of successive laser pulses, the focus volume is heated, and a typically drop-shaped modification forms in the workpiece. Thedeposited energy (given by pulse energy, pulse duration, pulse spacing, focusing, and wavelength) and modification position can be selected so that the topmost part of the modification nearly touches the workpiece surface. The thermal material expansion can then cause the surface to bulge outward.

For pulse spacings in the ns range, a residual heat of the previous laser pulse may still be present in the workpiece, and so the focus volume is heated step-by-step. The surrounding material can also be heated by means of thermal diffusion. Thermal electrons (corresponding to the Boltzmann distribution) can be produced by the high local temperatures. The presence of free electrons may imply that the next laser pulse need not rely on nonlinear multiphoton processes. Thus, the absorption probability can increase, and the next laser pulse can beabsorbed further up (in the direction of the workpiece surface or the laser optical unit). The absorption point can therefore shift upward during the process. Owing to thermal diffusion into the surrounding material, a droplet-shaped geometry can form. When the laser heating stops, e.g., because the laser is switched off, because scattering ensures that energy no longer arrives, or because the laser focus is moved away, the melted material solidifies again. As the solidification process is considerably faster than the melting process, the material can be frozen at a higher fictive temperature. This “modification” (approximately 100 μm high and 10 μm wide, depending on material and process parameters) has slightly different properties compared to the original volume material. Within a melted modification, there is an approximately radial temperature distribution: very hot inside (greater than about 2000° C.) and near room temperature on the outside. The viscosity of the material can also changes with the temperature, e.g., the cold outer material can be quite viscous, while the hot inner material can be more fluid. Moreover, there can also be thermal expansion of the glass with increasing temperature.

If the volume modification is situated close to the workpiece surface during the heating process (as described, the modification can grow upward towards the workpiece surface during the process), the thermal expansion of the hot inner material can cause the material to bulge outward. At the same time, high viscosity can prevent hot material from leaking out. The outcome may be sensitive to the position of the modification. If very hot material reaches the workpiece surface, the viscosity (and thus surface tension) may no longer be sufficient to prevent an uncontrolled expansion/explosion of the hot material outward. In the uncontrolled explosion, microfilaments and many different solidification formations can form. In the defined bulging of the material, a homogeneous spherical surface with minimal roughness can form, owing to the surface tension. During solidifying, the state of the material is frozen.

In some embodiments, the introduced laser energy is controlled in such a way, and the depth (z position) of the laser focus in the material is set in such a way, so as to prevent any uncontrolled expansion/explosion (analogous to a volcanic expansion/explosion). In these embodiments, the size of the bulge on the surface can be defined by the z position of the laser focus for a given number of pulses and pulse energy.

In another aspect, this disclosure provides methods of reshaping workpiece material from the volume to form a surface structure, without further material being deposited or removed. The process of solidifying the melted material can lead to smooth or homogeneous surface structures, on account of the surface tension.

In some embodiments, the beam cross section of the laser beam focused into the workpiece is formed to correspond to the desired cross section of the surface structure. An objective with high numerical aperture (NA greater than about 0.1) can be used for this purpose, so that high energy densities are achieved, and so nonlinear absorption mechanisms (multiphoton absorption, field ionization or tunnel ionization) can occur. If a laser beam with sufficient pulse energy is available, it is also possible, in some approaches, to use beam-shaping elements, such as, e.g., cylindrical lenses, a spatial light modulator (SLM) or diffractive optical elements, for spatial pulse- and beam-shaping (instead of or in addition to the objective mentioned), to produce other modifications in the material and therefore other structures on the surface.

In these embodiments, instead of an individual sphere-like bulge on the workpiece surface, linear or areal surface structures such as, e.g., “soft-focus” lines, crosses, hooks, etc. or also pyramid structures can be produced by means of a sequential construction made from a plurality of bulges. A scaling for the simultaneous construction of a plurality of surface structures can be provided by spatial beam-shaping (lens arrays, diffractive optical elements (DOEs)), as a result of which a plurality of laser spots can be produced next to one another at the same time and thus a plurality of modifications and surface structures can be produced at the same time.

In certain embodiments, the laser focus is point-shaped or Gaussian or runs linearly at right angles with respect to the beam axis, to melt a modification, which is drop-shaped in the longitudinal section, with a spherical top side in the workpiece interior.

The plurality of USP laser pulses can have a constant pulse spacing of, e.g., not more than 100 ns, not more than 50 ns, or not more than 20 ns, or can be focused into the workpiece in the form of laser bursts. In the latter case, the USP laser pulses forming a respective laser burst have a pulse spacing (ns range) which is less than the burst spacing (a few ms) between two laser bursts. By using such laser bursts, it is possible to stretch the melted modification and, as a result, to draw a surface structure somewhat further out from the workpiece surface in comparison to constant pulse spacings. In some embodiments, a laser burst has no more than 5 or 10 USP laser pulses, with a pulse spacing of not more than 20 ns, 50 ns, or 100 ns. The burst repetition rate can be selected to provide sufficient heat accumulation in the workpiece. For example, for a burst repetition rate of ˜100 kHz, a pulse energy of 10 μJ can be used; for a burst repetition rate of 1 MHz, a pulse energy of 1 μJ can be sufficient. Generally speaking, more average pulse power produces a larger melt volume in the workpiece.

In various embodiments, the USP laser pulse or pulses has/have a pulse energy of between 0.1 μJ and 100 μJ or between 1 μJ and 20 μJ or of approximately 10 P.

For producing linear surface structures, the laser beam can be moved over the workpiece and thus the laser focus can be moved through the workpiece interior. For approaches involving silica glass scattering at inhomogeneities and at the thermally induced refractive index profile of the modification can result in nonuniformities in the modification, so that, for example, an inscribed line can may have a nonuniform height. Uniform modifications can be achieved in homogeneous materials such as borosilicate glasses and with suitable process monitoring.

In one approach, identical surface structures are produced at different locations respectively with the same, fixedly predetermined pulse parameters. Instead of the laser focus continuously traveling through the material, a point-by-point procedure is employed: this involves firstly moving to a point and irradiating the material there with a fixedly defined energy (pulse energy multiplied by number of pulses), and so a bulge forms. After that, the same bulge is produced at another location with the same defined energy.

In another embodiment, when producing a surface structure, the workpiece surface is measured between the plurality of USP laser pulses and the laser beam is switched off or moved further, when a bulge height corresponding to the desired surface structure is achieved. The amount of energy needed to create a desired surface structure can be experimentally determined in advance or determined by observation, e.g., with a sensor system.

In various embodiments, the USP laser pulses can have a pulse duration of less than 50 ps, than 1 ps, or approximately 500 fs or less.

In a further aspect, the disclosure provides laser processing machines for producing surface structures on a laser-transparent workpiece, e.g., workpieces made of glass or plastic. The laser processing machines can include a USP laser for producing a pulsed laser beam in the form of USP laser pulses; a focusing unit, which focuses the laser beam onto the workpiece; and a machine controller, which is programmed to control the USP laser and the focusing unit in such a way that a modification, whose topmost part nearly touches the workpiece surface, is melted in the workpiece interior by heating the focus volume step-by-step.

In some embodiments, a beam-shaping unit for spatial pulse- and beam-shaping of the USP laser pulses is arranged in the beam path of the pulsed laser beam, such as, e.g., an objective with high numerical aperture (NA>0.1), a cylindrical lens, diffractive optical elements or an SLM modulator. In approaches that provide a high numerical aperture, a lower pulse energy may be used, and the size of the modifications may be kept smaller.

In certain embodiments, the laser processing machines include a sensor system, connected to the machine controller, for measuring the workpiece surface, for example in the form of a distance sensor arranged at a laser processing head. The sensor can optically or capacitively measure the distance to the workpiece surface. Once a bulge height corresponding to the desired surface structure is achieved, the laser beam can be switched off or moved further.

To move the laser beam relative to the workpiece, the laser processing machine can include a scanner for deflecting the laser beam over the workpiece or a movement unit for moving a laser processing head, from which the laser beam exits, and/or for moving the workpiece (e.g., an actuator coupled to a workpiece table that holds the workpiece during operation of the laser processing machine).

### DESCRIPTION OF DRAWINGS

Further advantages and advantageous embodiments of the subject matter of the invention are evident from the description, the claims and the drawing. Likewise, the features mentioned above and those presented below can be used in each case by themselves or as a plurality in any desired combinations. The embodiments shown and described should not be understood to be an exhaustive enumeration, but rather are of exemplary character for outlining the invention. In the figures:

FIG. 1 is a schematic diagram that shows an example of a laser processing machine for producing surface structures on a laser-transparent workpiece using a pulsed laser beam.

FIG. 2 is a longitudinal cross-section through an example of a workpiece with a plurality of surface structures produced along the advance direction of the pulsed laser beam.

### DETAILED DESCRIPTION

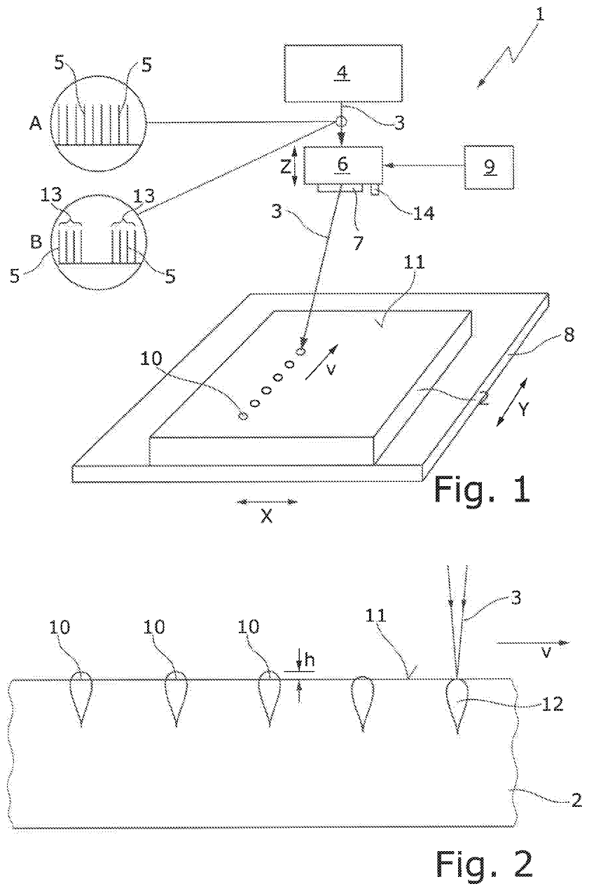

FIG. 1 shows an example of a laser processing machine 1 as described herein, which can be used to produce surface structures 10 on a laser-transparent workpiece 2 made of glass (e.g., fused silica) using a pulsed laser beam 3. By way of example, only glass is discussed in the following. The processes presented are, however, also conceivable for other laser-transparent materials, such as plastics.

The laser processing machine 1 includes a USP laser 4 for producing the laser beam 3 in the form of USP laser pulses 5 with pulse durations of less than 10 ps, e.g., in the femtosecond range; a laser processing head 6, which is height-adjustable in the Z direction, with an objective 7 of high numerical aperture (NA>0.1), from which the laser beam 3 exits in a manner focused toward the workpiece 2; a workpiece table 8, which is adjustable in the X-Y direction, on which the workpiece 2 lies; and a machine controller 9, which controls the laser parameters of the USP laser 4, the Z position of the laser processing head 6, and the X-Y movement of the workpiece table 8.

For producing a surface structure 10, a plurality of USP laser pulses 5 are focused into the workpiece 2 through the workpiece surface 11, in order to melt a drop-shaped modification 12, which is convex toward the workpiece surface 11, with a spherical top side in the workpiece interior by heating the focus volume step-by-step. In this way, the pulse parameters (given by pulse energy, number of pulses, pulse duration, temporal pulse spacing, wavelength, focusing) of the plurality of USP laser pulses 5 and the depth of the laser focus in the workpiece 2 are chosen in such a way that the topmost part of the melted modification 12 nearly touches the workpiece surface 11 (FIG. 2). Then, the workpiece surface 11 bulges outward to form a surface structure 10 in the shape of a sphere-like segment by means of thermal material expansion of the melted modification 12. In this way, the Z position of the laser focus determines the magnitude of the diameter of the sphere-like surface structure 10 on the workpiece surface 11.

In various embodiments, the plurality of USP laser pulses 5 can, as detail A in FIG. 1 shows, have a constant pulse spacing or a constant repetition rate or, as detail B in FIG. 1 shows, be grouped in a plurality of laser bursts 13, wherein the USP laser pulses 5 forming a respective laser burst 13 have a ns pulse spacing, which is therefore considerably less than the ms burst spacing between two laser bursts 13. By using laser bursts 13, it is possible to stretch the melted modification 12 in the Z direction and, as a result, to draw the surface structure 10 somewhat further out from the workpiece surface 11 in comparison to the constant pulse spacings shown in detail A. The burst repetition rate may be selected to be sufficiently high enough to enable heat accumulation in the workpiece 2. For this purpose, for example, a pulse energy of 10 μJ may be provided for a burst repetition rate of ˜100 kHz, while a pulse energy of 1 μJ may be provided for a burst repetition rate of 1 MHz. In general, more average power produces a larger melt volume in the workpiece 2.

Instead of the objective 7 of high numerical aperture (NA>0.1), other beam-shaping units can also be arranged in the beam path of the laser beam 3 for spatial pulse- and beam-shaping of the USP laser pulses 5, e.g., cylindrical lenses, diffractive optical elements or an SLM modulator, in order to produce other modifications 12 in the material and thus other surface structures 10.

In embodiments for producing a linear surface structure 10, the laser beam 3 can be continuously moved over the workpiece 2 in the advance direction v and thus the laser focus can continuously move through the workpiece interior. In other embodiments, as shown in FIG. 2, identical surface structures 10 can be produced at different locations respectively with the same, fixedly predetermined pulse parameters by sequential movement of the laser beam 3 in the advance direction v. When producing a surface structure 10, the workpiece surface 11 can be measured between the plurality of USP laser pulses 5 using a sensor system 14, e.g., attached to the laser processing head 6; with input from the sensor system, the machine controller 9 can then switch off or move the laser beam 3 further as soon as a bulge height h corresponding to the desired surface structure 10 is achieved. The surface structures 10 can thus be produced in a controlled manner, either a sequential approach or by automatic process monitoring.

In some contexts, alongside the thermal expansion of the material, other processes which would lead to a bulge can may occur. For example, the material around the region of the intended bulge could be modified so that internal stresses are produced, which cause the bulge.

Experiments carried out with the following parameters led to surface structures 10 with suitable quality:

average laser power 8 W

focusing: NA 0.2

focal length: 11 mm

laser spot diameter on the workpiece: approx. 4 μm

pulse duration 500 fs

laser burst with 4 laser pulses with pulse spacing of 20 ns
burst repetition rate 200 kHz
pulse energy: 10 μJ

What is claimed is:

1. A method for producing surface structures on a laser-transparent workpiece, the method comprising:
irradiating the laser-transparent workpiece with a pulsed laser beam in the form of ultra-short pulse (USP) laser pulses, wherein at least one USP laser pulse is focused into the laser-transparent workpiece through a workpiece surface, thereby melting a modification to form a melted modification in an interior of the workpiece by heating a focus volume in the interior of the workpiece;
wherein pulse parameters of the at least one USP laser pulse and depth of laser focus in the workpiece are selected so that a topmost part of the melted modification nearly touches the workpiece surface and the workpiece surface bulges outward to form a convex surface structure by thermal material expansion of the melted modification.

2. The method of claim 1, wherein a plurality of USP laser pulses are focused into the laser-transparent workpiece through the workpiece surface, thereby melting the modification in the workpiece interior by heating the focus volume step-by-step; and
wherein pulse parameters of the plurality of laser pulses and the depth of the laser focus in the workpiece are selected so that a topmost part of the melted modification nearly touches the workpiece surface and the workpiece surface bulges outward to form the convex surface structure by thermal material expansion of the melted modification.

3. The method of claim 2, wherein the plurality of USP laser pulses have a constant pulse spacing.

4. The method of claim 3, wherein the constant pulse spacing is not more than 100 ns.

5. The method of claim 4, wherein the constant pulse spacing is not more than 50 ns.

6. The method of claim 5, wherein the constant pulse spacing is not more than 20 ns.

7. The method of claim 2, wherein the USP laser pulses in the plurality of USP laser pulses are focused into the workpiece in the form of a plurality of laser bursts, where the USP laser pulses forming each of the laser bursts in the plurality of laser bursts have a pulse spacing that is less than a burst spacing between consecutive laser bursts in the plurality of laser bursts.

8. The method of claim 7, wherein each laser burst in the plurality of laser bursts includes no more than 10 USP laser pulses, and the pulse spacing is not more than 100 ns.

9. The method of claim 7, wherein the burst spacing corresponds to a burst repetition rate between 10 kHz and 10 MHz.

10. The method of claim 9, wherein the burst repetition rate is between 100 kHz and 1 MHz.

11. The method of claim 10, wherein the burst repetition rate is approximately 200 kHz.

12. The method of claim 1, wherein the at least one USP laser pulse has a pulse energy of between 0.1 μJ and 100 μJ.

13. The method of claim 1, wherein a beam cross section of the laser beam focused into the workpiece is shaped according to a desired cross section of the surface structures.

14. The method of claim 1, wherein the laser beam has a point-shaped or Gaussian laser focus or a linear laser focus running at right angles with respect to a beam axis, thereby melting a modification which is drop-shaped in a longitudinal cross section, with a spherical top side in the workpiece interior.

15. The method of claim 1, further comprising:
producing linear surface structures by moving the laser beam over the workpiece and thus moving the laser focus through the workpiece interior.

16. The method of claim 1, further comprising:
producing identical surface structures at different locations along the workpiece surface with identical predetermined pulse parameters.

17. The method of claim 1, wherein the at least one USP laser pulse is a plurality of USP laser pulses, and the method further comprises:
measuring the workpiece surface between pulses in the plurality of USP laser pulses; and
switching off or moving the laser beam as soon as a bulge height corresponding to a desired surface structure is measured.

18. The method of claim 1, wherein the at least one USP laser pulse has a pulse duration of less than 50 ps.

19. A laser processing machine for producing surface structures on a laser-transparent workpiece, comprising:
a laser for producing a pulsed laser beam in the form of ultra-short pulse (USP) laser pulses;
a focusing structure for delivering energy of the laser beam onto the workpiece; and
a machine controller coupled to the laser and the focusing structure and configured to operate the laser and the focusing unit to melt a modification by heating a focus volume in an interior of the workpiece, where a topmost part of the modification nearly touches a workpiece surface.

20. The laser processing machine of claim 19, further comprising one or more a beam-shaping elements arranged in a beam path of the pulsed laser beam.

21. The laser processing machine of claim 20, wherein the one or more beam-shaping elements include one or more cylindrical lenses, spatial light modulators, or diffractive optical elements.

22. The laser processing machine of claim 19, further comprising a sensor system, connected to the machine controller, for measuring the workpiece surface.

23. The laser processing machine of claim 19, wherein the focusing structure includes a scanner for deflecting the laser beam over the workpiece.

24. The laser processing machine of claim 19, further comprising:
a workpiece table for holding the workpiece; and
an actuator coupled to the workpiece table to provide relative movement between the workpiece table and the laser.
